(19) United States
(12) Patent Application Publication
(10) Pub. No.: US 2015/0186995 A1
(43) Pub. Date: Jul. 2, 2015

(54) Systems and Methods to Monitor Risk of Trading Strategies

(71) Applicant: Trading Technologies International, Inc., Chicago, IL (US)

(72) Inventors: Andrew Theodore Renalds, Chicago, IL (US); Sun Joong Yoo, Chicago, IL (US)

(73) Assignee: Trading Technologies International, Inc., Chicago, IL (US)

(21) Appl. No.: 14/140,952

(22) Filed: Dec. 26, 2013

(51) Int. Cl. G06Q 40/04

(52) U.S. Cl. CPC G06Q 40/04

(57) ABSTRACT

Example methods, systems, and computer-readable media are disclosed to monitor risk of trading strategies. An example method for algorithmic trading in an electronic trading environment includes receiving a definition for a spread trading strategy including a strategy activation event. The trading strategy is between a first tradeable object and a second tradeable object. The example method includes defining a position risk limit. The example method includes detecting an occurrence of the strategy activation event within one or more markets. The example method includes calculating a first quantity for the first tradeable object. The example method includes determining a second quantity including the first quantity and a third quantity associated with an open trade. The example method includes comparing the second quantity to the position risk limit. The example method includes sending a first order for the first tradeable object if the second quantity does not exceed the position risk limit.

### BACKGROUND

An electronic trading system generally includes a trading device in communication with an electronic exchange. The electronic exchange sends information about a market, such as prices and quantities, to the trading device. The trading device sends messages, such as messages related to orders, to the electronic exchange. The electronic exchange attempts to match quantity of an order with quantity of one or more contra-side orders.

Traders sometimes prefer to trade only one tradeable object at a time, and sometimes traders wish to trade more than one tradeable object at a time in a strategy referred to as spreading or strategy trading. For example, a trader may buy multiple different tradeable objects, sell multiple different tradeable objects, or buy and sell a combination of different tradeable objects. While the different buys and sells may comprise unrelated positions for the trader, they may alternatively be part of a specific trading strategy such as a spread.

In order to manage the risks associated with trading multiple tradeable objects and/or maintaining multiple open positions, risk management systems may be utilized to monitor all orders, fills and price information for any contracts the trader has working in the market. The risk management systems process the monitored information to account for the position and order quantity of each contract a user has working in the market. The resulting risk position may be updated each time a trading algorithm initiates sending of a trade action to ensure that the trading activity is within desired limits.

### BRIEF DESCRIPTION OF THE FIGURES

Certain embodiments are disclosed with reference to the following drawings.

FIG. 1 illustrates a block diagram representative of an example electronic trading system in which certain embodiments may be employed.

FIG. 2 illustrates a block diagram of another example electronic trading system in which certain embodiments may be employed.

FIG. 3 illustrates a block diagram of an example computing device which may be used to implement the disclosed embodiments.

FIG. 4 illustrates a block diagram of a trading strategy which may be employed with certain disclosed embodiments.

FIG. 5 illustrates a flow diagram of an example method for defining a trading strategy.

FIG. 6 illustrates a flow diagram of an example method for implementing a trading strategy.

FIG. 7 illustrates a flow diagram of an example method for increasing a position risk limit.

FIG. 8 is a block diagram of an example implementation of an example trading manager which may be used to implement disclosed embodiments.

Certain embodiments will be better understood when read in conjunction with the provided figures, which illustrate examples. It should be understood, however, that the embodiments are not limited to the arrangements and instrumentality shown in the attached figures.

### DETAILED DESCRIPTION

Electronic trading applications may enable a user (for example, a trader) to design and deploy an automated trading algorithm. Trading algorithms generally specify that certain trade actions should be taken in response to the detection of one or more predefined market conditions. Trade actions include, but are not limited to, submitting, cancelling, or re-pricing a trade order. Automated trading algorithms may be configured to operate with minimal user intervention once they have been deployed and activated. Once deployed, an automated trading algorithm may monitor the market awaiting detection of one or more predefined market conditions. The activated trading algorithm may, when a desired condition is detected in the market, automatically (e.g., with little or no human interaction) initiate sending of a trade action. Detection of a market condition may include a determination that the desired market condition has occurred, a classification or other identification of the desired market condition, and/or the storage or recordation of the desired market condition. The autonomous manner in which an automated trading algorithm operates means that number and frequency with which a trade action may be initiated cannot be predicted (i.e., a user does not know before deployment of the trading algorithm how many times one of the pre-defined market conditions may be detected much less how many times a trade action may be initiated.)

In addition to trading single items, an automated trading algorithm may trade more than one item according to an automated trading strategy. An automated trading strategy may define a relationship between two or more items to be traded. Each trade of an item in an automated trading strategy may be referred to as a leg of the trading strategy. Items in an automated trading strategy may also be referred to as tradeable objects. Once defined, items in the automated trading strategy may then be traded together according to the defined relationship. One common trading strategy is a spread. Trading according to a spread may also be referred to as spread trading. Automated trading algorithms utilizing spread trading may attempt to capitalize on changes or movements in the relationships between the items in the trading strategy, for example. The complexity of the trades that may be initiated by the automated trading strategy combined with the uncertainty surrounding the frequency with which a trade action may be initiated make determining how many trades will occur in connection with the operation of the trading strategy unpredictable.

In order to address the unpredictability embodied by automated trading strategies and automated trading algorithms, current risk management techniques provide tools and mechanisms to process current market data and generate a specific risk value before initiating sending an order related to the legs defined by an automated trading strategy. Current risk management techniques incur greater latencies due to the precision and/or frequency at which the risk value calculations are performed.

Embodiments disclosed herein generally relate to risk management techniques that are configured to ensure that a user's risk account has a current risk balance sufficient to allow the trading application to initiate sending of a trade action specified by the automated trading strategy. The risk balance or risk pool represent a predetermined value that may act as a cushion or threshold that limits the exposure associated with an automated trading strategy. Individual risk balances may, in certain examples, be established for specific automated trading strategies, and/or grouped or collective risk balances may similarly be established for one or more type or class of automated trading strategy. Examples disclosed herein provide a system to confirm that the trading strategy is maintaining a positive risk balance and operating within a pre-defined risk pool or other risk-related limits (e.g., a position risk limit). For example, prior to activation of the trading strategy, the user may define or establish an overall risk limit and/or create a risk pool via the trading application. The risk pool defines an upper limit and/or a maximum allowable risk associated with all of the currently active trading strategies. In this way, the risk pool may be established before the trading strategy is activated and the extent of the risk associated with the active trading strategies is known. The risk pool is, in turn, queried before the trading strategy initiates sending of any trade actions in response to a detected condition in the market and in this way confirms that the trading strategy is operating within the risk balance. Providing expedited risk management techniques prior to initiating sending of a trade action specified by a trading strategy enables faster execution of the trading strategy as compared to risk management techniques implemented while the trading strategies are executing.

Examples disclosed herein enable a user to define an automated trading strategy, a strategy activation event, and/or a position risk pool prior to the trading strategy initiating sending of a trade action. Defining a trading strategy includes defining one or more tradeable objects and relationships between the tradeable objects. A strategy activation event defines one or more conditions (e.g., market conditions, time of day or week, current events, etc.) set to occur prior to an execution of one or more trade actions specified by the trading strategy. In other words, a trading algorithm executing a trading strategy does not initiate sending of a trade action until an occurrence of the strategy activation event is detected. Activation event data (e.g., information related to market conditions, time of day or week, current events, etc.) is collected and monitored to detect occurrences of strategy activation events. A position risk pool is used to confirm a trading algorithm executing a trading strategy is operating within risk-related limits set by a user prior to initiating sending of a trade action specified by the trading strategy. For example, a position risk pool establishes a quantity of orders associated with a user not to be exceeded by the trading strategy.

Once the trading strategy, strategy activation event, and/or position risk limit have been defined by a user, the trading strategy may be activated for automatic operation. Activation of the automated trading strategy may include deploying the trading strategy to a server, executing the trading strategy from a trading device, changing or uploading parameters and/or conditions related to an existing trading strategy, for example. In operation, an example activated trading strategy as disclosed herein collects and monitors activation event data to detect an occurrence of the defined strategy activation event. Once detected, examples disclosed herein determine a price and quantity for a tradeable object associated with an order to be placed according to the trading strategy. The price and quantity are determined using market data received from, for example, an exchange to be used to execute trades by the trading strategy.

Examples disclosed herein also determine open positions associated with the user. Open positions include trades that have been established and/or entered by, for example, an automated trading algorithm, but not yet closed. Examples disclosed herein determine a combined quantity including the quantity associated with the trade action (e.g., an order to be placed according to the trading strategy) and quantities associated with the open positions. For example, where the quantity associated with the order to be placed according to the trading strategy is ten and the quantities associated with the open positions is twenty, the combined quantity is thirty. The combined quantity is compared to the previously defined position risk pool, which acts as a threshold that prevents the combined quantity from exceeding the defined risk tolerance. If the combined quantity is too large (e.g., the combined quantity exceeds the position risk pool), the trading strategy is prevented from initiating sending of the trade action (e.g., the trading strategy is stopped). In some configurations, an error message may also be generated to inform a user that the trading strategy has been prevented from sending the trade action because the position risk limit has been exceeded. If the combined quantity is below or within the value associated with the position risk pool, the position risk pool is updated based on the quantity associated with the order to be placed and the trading strategy is allowed to execute (e.g., the order including the determined price and quantity is allowed to be sent to the exchange). In some examples, the quantity associated with the order to be placed is compared to an available quantity of the position risk pool to determine if the trading strategy may initiate sending of the trade action. In some examples, an increase in the position risk pool may be requested. For example, if the initial position risk pool has been met, an increase may be requested so that an increased position risk pool may be used when analyzing the trading strategy.

Although this description discloses embodiments including, among other components, software executed on hardware, it should be noted that the embodiments are merely illustrative and should not be considered as limiting. For example, it is contemplated that any or all of these hardware and software components may be embodied exclusively in hardware, exclusively in software, exclusively in firmware, or in any combination of hardware, software, and/or firmware. Accordingly, certain embodiments may be implemented in other ways.

### I. Brief Description of Certain Embodiments

Example methods, systems, and computer-readable media are disclosed to monitor risk of trading strategies. An example method for algorithmic trading in an electronic trading environment includes receiving, at a computing device, a definition for an algorithmic spread trading strategy including a desired spread price and a strategy activation event. The spread trading strategy is between a first tradeable object and a second tradeable object. The example method includes defining a position risk limit, wherein the risk position limit is associated with an instance of the algorithmic spread trading strategy. The example method includes detecting, at the computing device, an occurrence of the strategy activation event within one or more markets offering the first tradeable object and the second tradeable object. The example method includes calculating, at the computing device, a first price and a first quantity for the first tradeable object. The first price and the first quantity are computed based on market conditions in the second tradeable object. The example method includes determining a second quantity including the first quantity and a third quantity associated with an open trade. The example method includes comparing the second quantity to the position risk limit. The example method includes sending, by the computing device, a first order to buy or sell the first tradeable object of the algorithmic spread trading strategy if the second quantity does not exceed the position risk limit. The first quantity of the first order is submitted at the first price.

An example system for algorithmic trading in an electronic trading environment includes a trading control module to receive a definition for an algorithmic spread trading strategy including a desired spread price and a strategy activation event. The spread trading strategy is between a first tradeable object and a second tradeable object. The example trading control module is to define a position risk limit, wherein the risk position limit is associated with an instance of the algorithmic spread trading strategy. The example system includes an event detection module to detect an occurrence of the strategy activation event within one or more markets offering the first tradeable object and the second tradeable object. The example system includes a position risk control module to calculate a first price and a first quantity for the first tradeable object. The first price and the first quantity are computed based on market conditions in the second tradeable object. The example position risk control module is to determine a second quantity including the first quantity and a third quantity associated with an open trade. The example position risk control module is to compare the second quantity to the position risk limit. The example trading control module is to send a first order to buy or sell the first tradeable object of the algorithmic spread trading strategy if the second quantity does not exceed the position risk limit. The first quantity of the first order is submitted at the first price.

An example computer-readable storage medium comprises instructions that, when executed, cause a computing device to receive a definition for an algorithmic spread trading strategy including a desired spread price and a strategy activation event. The spread trading strategy is between a first tradeable object and a second tradeable object. The example instructions cause the computing device to define a position risk limit, wherein the risk position limit is associated with an instance of the algorithmic spread trading strategy. The example instructions cause the computing device to detect an occurrence of the strategy activation event within one or more markets offering the first tradeable object and the second tradeable object. The example instructions cause the computing device to calculate a first price and a first quantity for the first tradeable object. The first price and the first quantity are computed based on market conditions in the second tradeable object. The example instructions cause the computing device to determine a second quantity including the first quantity and a third quantity associated with an open trade. The example instructions cause the computing device to compare the second quantity to the position risk limit. The example instructions cause the computing device to send a first order to buy or sell the first tradeable object of the algorithmic spread trading strategy if the second quantity does not exceed the position risk limit. The first quantity of the first order is submitted at the first price.

### II. Example Electronic Trading System

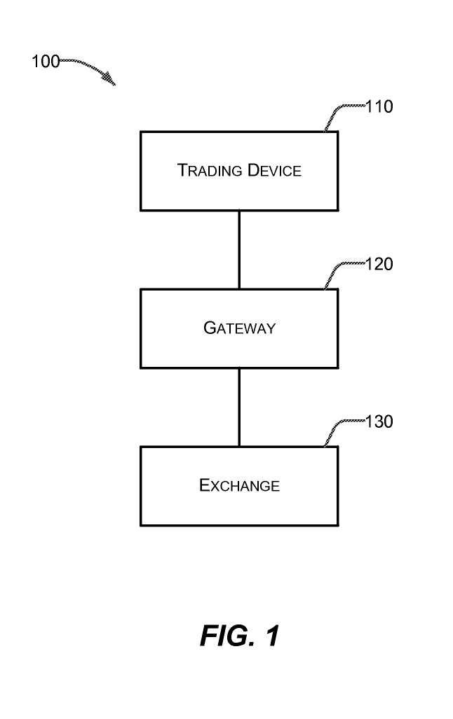

FIG. 1 illustrates a block diagram representative of an example electronic trading system 100 in which certain embodiments may be employed. The system 100 includes a trading device 110, a gateway 120, and an exchange 130. The trading device 110 is in communication with the gateway 120. The gateway 120 is in communication with the exchange 130. As used herein, the phrase “in communication” encompasses direct communication and/or indirect communication through one or more intermediary components. The exemplary electronic trading system 100 depicted in FIG. 1 may be in communication with additional components, subsystems, and elements to provide additional functionality and capabilities without departing from the teaching and disclosure provided herein.

In operation, the trading device 110 may receive market data from the exchange 130 through the gateway 120. A user may utilize the trading device 110 to monitor this market data and/or base a decision to send an order message to buy or sell one or more tradeable objects to the exchange 130.

Market data may include data about a market for a tradeable object. For example, market data may include the inside market, market depth, last traded price (“LTP”), a last traded quantity (“LTQ”), or a combination thereof. The inside market is the lowest available ask price (best offer) and the highest available bid price (best bid) in the market for a particular tradeable object at a particular point in time (since the inside market may vary over time). Market depth refers to quantities available at the inside market and at other prices away from the inside market. Due to the quantity available, there may be “gaps” in market depth.

A tradeable object is anything which may be traded. For example, a certain quantity of the tradeable object may be bought or sold for a particular price. A tradeable object may include, for example, financial products, stocks, options, bonds, future contracts, currency, warrants, funds derivatives, securities, commodities, swaps, interest rate products, index-based products, traded events, goods, or a combination thereof. A tradeable object may include a product listed and/or administered by an exchange (for example, the exchange 130), a product defined by the user, a combination of real or synthetic products, or a combination thereof. There may be a synthetic tradeable object that corresponds and/or is similar to a real tradeable object.

An order message is a message that includes a trade order. A trade order may be, for example, a command to place an order to buy or sell a tradeable object, a command to initiate managing orders according to a defined trading strategy, a command to change or cancel a previously submitted order (for example, modify a working order), an instruction to an electronic exchange relating to an order, or a combination thereof

The trading device 110 may include one or more electronic computing platforms. For example, the trading device 110 may include a desktop computer, hand-held device, laptop, server, a portable computing device, a trading terminal, an embedded trading system, a workstation, an algorithmic trading system such as a “black box” or “grey box” system, cluster of computers, or a combination thereof. As another example, the trading device 110 may include a single or multi-core processor in communication with a memory or other storage medium configured to accessibly store one or more computer programs, applications, libraries, computer readable instructions, and the like, for execution by the processor.

As used herein, the phrases “configured to” and “adapted to” encompass that an element, structure, or device has been modified, arranged, changed, or varied to perform a specific function or for a specific purpose.

By way of example, the trading device 110 may be implemented as a personal computer running a copy of X_TRADER®, an electronic trading platform provided by Trading Technologies International, Inc. of Chicago, Ill. (“Trading Technologies”). As another example, the trading device 110 may be a server running a trading application providing automated trading tools such as ADL®, AUTOSPREADER®, and/or AUTOTRADER™, also provided by Trading Technologies. In yet another example, the trading device 110 may include a trading terminal in communication with a server, where collectively the trading terminal and the server are the trading device 110.

The trading device 110 is generally owned, operated, controlled, programmed, configured, or otherwise used by a user. As used herein, the phrase “user” may include, but is not limited to, a human (for example, a trader), trading group (for example, group of traders), or an electronic trading device (for example, an algorithmic trading system). One or more users may be involved in the ownership, operation, control, programming, configuration, or other use, for example.

The trading device 110 may include one or more trading applications. As used herein, a trading application is an application that facilitates or improves electronic trading. A trading application provides one or more electronic trading tools. For example, a trading application stored by a trading device may be executed to arrange and display market data in one or more trading windows. In another example, a trading application may include an automated spread trading application providing spread trading tools. In yet another example, a trading application may include an algorithmic trading application that automatically processes an algorithm and performs certain actions, such as placing an order, modifying an existing order, deleting an order. In yet another example, a trading application may provide one or more trading screens. A trading screen may provide one or more trading tools that allow interaction with one or more markets. For example, a trading tool may allow a user to obtain and view market data, set order entry parameters, submit order messages to an exchange, deploy trading algorithms, and/or monitor positions while implementing various trading strategies. The electronic trading tools provided by the trading application may always be available or may be available only in certain configurations or operating modes of the trading application.

A trading application may include computer readable instructions that are stored in a computer readable medium and executable by a processor. A computer readable medium may include various types of volatile and non-volatile storage media, including, for example, random access memory, read-only memory, programmable read-only memory, electrically programmable read-only memory, electrically erasable read-only memory, flash memory, any combination thereof, or any other tangible data storage device. As used herein, the term non-transitory or tangible computer readable medium is expressly defined to include any type of computer readable storage media and to exclude propagating signals.

One or more components or modules of a trading application may be loaded into the computer readable medium of the trading device 110 from another computer readable medium. For example, the trading application (or updates to the trading application) may be stored by a manufacturer, developer, or publisher on one or more CDs or DVDs, which are then loaded onto the trading device 110 or to a server from which the trading device 110 retrieves the trading application. As another example, the trading device 110 may receive the trading application (or updates to the trading application) from a server, for example, via the Internet or an internal network. The trading device 110 may receive the trading application or updates when requested by the trading device 110 (for example, “pull distribution”) and/or un-requested by the trading device 110 (for example, “push distribution”).

The trading device 110 may be adapted to send order messages. For example, the order messages may be sent to through the gateway 120 to the exchange 130. As another example, the trading device 110 may be adapted to send order messages to a simulated exchange in a simulation environment which does not effectuate real-world trades.

The order messages may be sent at the request of a user. For example, a trader may utilize the trading device 110 to send an order message or manually input one or more parameters for a trade order (for example, an order price and/or quantity). As another example, an automated trading tool provided by a trading application may calculate one or more parameters for a trade order and automatically send the order message. In some instances, an automated trading tool may prepare the order message to be sent but not actually send it without confirmation from a user.

An order message may be sent in one or more data packets or through a shared memory system. For example, an order message may be sent from the trading device 110 to the exchange 130 through the gateway 120. The trading device 110 may communicate with the gateway 120 using a local area network, a wide area network, a wireless network, a virtual private network, a T1 line, a T3 line, an integrated services digital network (“ISDN”) line, a point-of-presence, the Internet, and/or a shared memory system, for example.

The gateway 120 may include one or more electronic computing platforms. For example, the gateway 120 may implemented as one or more desktop computer, hand-held device, laptop, server, a portable computing device, a trading terminal, an embedded trading system, workstation with a single or multi-core processor, an algorithmic trading system such as a “black box” or “grey box” system, cluster of computers, or any combination thereof.

The gateway 120 may facilitate communication. For example, the gateway 120 may perform protocol translation for data communicated between the trading device 110 and the exchange 130. The gateway 120 may process an order message received from the trading device 110 into a data format understood by the exchange 130, for example. Similarly, the gateway 120 may transform market data in an exchange-specific format received from the exchange 130 into a format understood by the trading device 110, for example.

The gateway 120 may include a trading application, similar to the trading applications discussed above, that facilitates or improves electronic trading. For example, the gateway 120 may include a trading application that tracks orders from the trading device 110 and updates the status of the order based on fill confirmations received from the exchange 130. As another example, the gateway 120 may include a trading application that coalesces market data from the exchange 130 and provides it to the trading device 110. In yet another example, the gateway 120 may include a trading application that provides risk processing, calculates implieds, handles order processing, handles market data processing, or a combination thereof.

In certain embodiments, the gateway 120 communicates with the exchange 130 using a local area network, a wide area network, a virtual private network, a T1 line, a T3 line, an ISDN line, a point-of-presence, the Internet, and/or a shared memory system, for example.

The exchange 130 may be owned, operated, controlled, or used by an exchange entity. Example exchange entities include the CME Group, the London International Financial Futures and Options Exchange, the Intercontinental Exchange, and Eurex. The exchange 130 may include an electronic matching system, such as a computer, server, or other computing device, which is adapted to allow tradeable objects, for example, offered for trading by the exchange, to be bought and sold. The exchange 130 may include separate entities, some of which list and/or administer tradeable objects and others which receive and match orders, for example. The exchange 130 may include an electronic communication network (“ECN”), for example.

The exchange 130 may be an electronic exchange. The exchange 130 is adapted to receive order messages and match contra-side trade orders to buy and sell tradeable objects. Unmatched trade orders may be listed for trading by the exchange 130. The trade orders may include trade orders received from the trading device 110 or other devices in communication with the exchange 130, for example. For example, typically the exchange 130 will be in communication with a variety of other trading devices (which may be similar to trading device 110) which also provide trade orders to be matched.

The exchange 130 is adapted to provide market data. Market data may be provided in one or more messages or data packets or through a shared memory system. For example, the exchange 130 may publish a data feed to subscribing devices, such as the trading device 110 or gateway 120. The data feed may include market data.

The system 100 may include additional, different, or fewer components. For example, the system 100 may include multiple trading devices, gateways, and/or exchanges. In another example, the system 100 may include other communication devices, such as middleware, firewalls, hubs, switches, routers, servers, exchange-specific communication equipment, modems, security managers, and/or encryption/decryption devices.

### III. Expanded Example Electronic Trading System

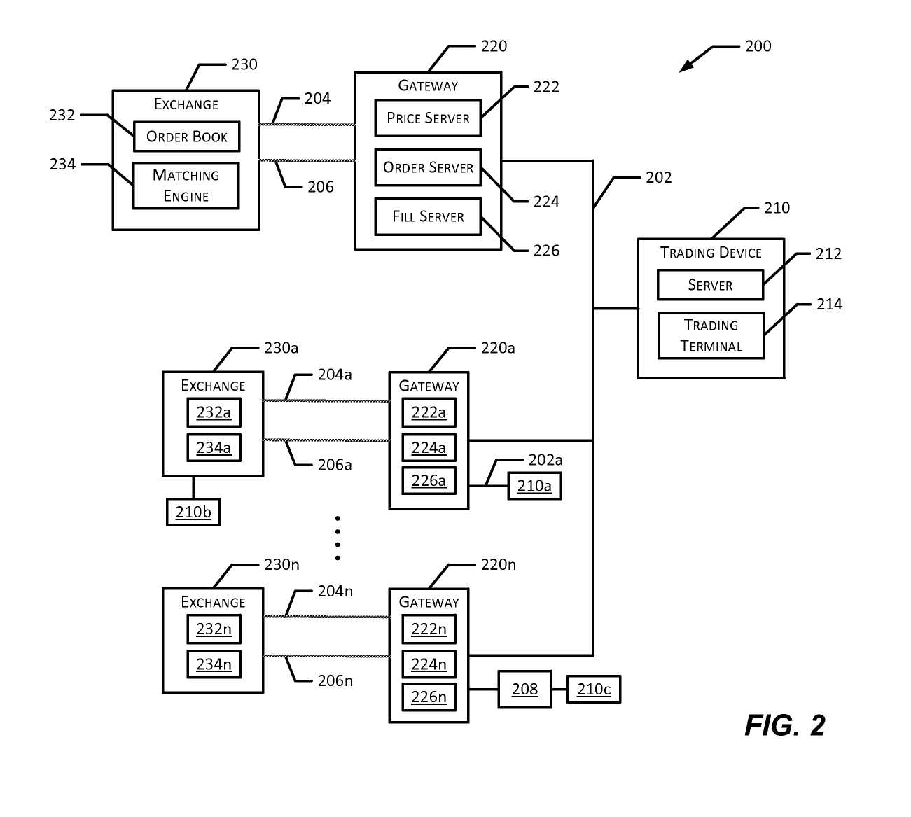

FIG. 2 illustrates a block diagram of another example electronic trading system 200 in which certain embodiments may be employed. In this example, a trading device 210 may utilize one or more communication networks to communicate with a gateway 220 and exchange 230. For example, the trading device 210 utilizes network 202 to communicate with the gateway 220, and the gateway 220, in turn, utilizes the networks 204 and 206 to communicate with the exchange 230. As used herein, a network facilitates or enables communication between computing devices such as the trading device 210, the gateway 220, and the exchange 230.

The following discussion generally focuses on the trading device 210, gateway 220, and the exchange 230. However, the trading device 210 may also be connected to and communicate with “n” additional gateways (individually identified as gateways 220a-220n, which may be similar to gateway 220) and “n” additional exchanges (individually identified as exchanges 230a-230n, which may be similar to exchange 230) by way of the network 202 (or other similar networks). Additional networks (individually identified as networks 204a-204n and 206a-206n, which may be similar to networks 204 and 206, respectively) may be utilized for communications between the additional gateways and exchanges. The communication between the trading device 210 and each of the additional exchanges 230a-230n need not be the same as the communication between the trading device 210 and exchange 230. Generally, each exchange has its own preferred techniques and/or formats for communicating with a trading device, a gateway, the user, or another exchange. It should be understood that there is not necessarily a one-to-one mapping between gateways 220a-220n and exchanges 230a-230n. For example, a particular gateway may be in communication with more than one exchange. As another example, more than one gateway may be in communication with the same exchange. Such an arrangement may, for example, allow one or more trading devices 210 to trade at more than one exchange (and/or provide redundant connections to multiple exchanges).

Additional trading devices 210a-210n, which may be similar to trading device 210, may be connected to one or more of the gateways 220a-220n and exchanges 230a-230n. For example, the trading device 210a may communicate with the exchange 230a via the gateway 220a and the networks 202a, 204a and 206a. In another example, the trading device 210b may be in direct communication with exchange 230a. In another example, trading device 210c may be in communication with the gateway 220n via an intermediate device 208 such as a proxy, remote host, or WAN router.

The trading device 210, which may be similar to the trading device 110 in FIG. 1, includes a server 212 in communication with a trading terminal 214. The server 212 may be located geographically closer to the gateway 220 than the trading terminal 214 in order to reduce latency. In operation, the trading terminal 214 may provide a trading screen to a user and communicate commands to the server 212 for further processing. For example, a trading algorithm may be deployed to the server 212 for execution based on market data. The server 212 may execute the trading algorithm without further input from the user. In another example, the server 212 may include a trading application providing automated trading tools and communicate back to the trading terminal 214. The trading device 210 may include additional, different, or fewer components.

In operation, the network 202 may be a multicast network configured to allow the trading device 210 to communicate with the gateway 220. Data on the network 202 may be logically separated by subject such as, for example, by prices, orders, or fills. As a result, the server 212 and trading terminal 214 can subscribe to and receive data such as, for example, data relating to prices, orders, or fills, depending on their individual needs.

The gateway 220, which may be similar to the gateway 120 of FIG. 1, may include a price server 222, order server 224, and fill server 226. The gateway 220 may include additional, different, or fewer components. The price server 222 may process price data. Price data includes data related to a market for one or more tradeable objects. The order server 224 processes order data. Order data is data related to a user's trade orders. For example, order data may include order messages, confirmation messages, or other types of messages. The fill server collects and provides fill data. Fill data includes data relating to one or more fills of trade orders. For example, the fill server 226 may provide a record of trade orders, which have been routed through the order server 224, that have and have not been filled. The servers 222, 224, and 226 may run on the same machine or separate machines. There may be more than one instance of the price server 222, the order server 224, and/or the fill server 226 for gateway 220. In certain embodiments, the additional gateways 220a-220n may each includes instances of the servers 222, 224, and 226 (individually identified as servers 222a-222n, 224a-224n, and 226a-226n).

The gateway 220 may communicate with the exchange 230 using one or more communication networks. For example, as shown in FIG. 2, there may be two communication networks connecting the gateway 220 and the exchange 230. The network 204 may be used to communicate market data to the price server 222. In some instances, the exchange 230 may include this data in a data feed that is published to subscribing devices. The network 206 may be used to communicate order data to the order server 224 and the fill server 226. The network 206 may also be used to communicate order data from the order server 224 to the exchange 230.

The exchange 230, which may be similar to the exchange 130 of FIG. 1, includes an order book 232 and a matching engine 234. The exchange 230 may include additional, different, or fewer components. The order book 232 is a database that includes data relating to unmatched trade orders that have been submitted to the exchange 230. For example, the order book 232 may include data relating to a market for a tradeable object, such as the inside market, market depth at various price levels, the last traded price, and the last traded quantity. The matching engine 234 may match contra-side bids and offers pending in the order book 232. For example, the matching engine 234 may execute one or more matching algorithms that match contra-side bids and offers. A sell order is contra-side to a buy order. Similarly, a buy order is contra-side to a sell order. A matching algorithm may match contra-side bids and offers at the same price, for example. In certain embodiments, the additional exchanges 230a-230n may each include order books and matching engines (individually identified as the order book 232a-232n and the matching engine 234a-234n, which may be similar to the order book 232 and the matching engine 234, respectively). Different exchanges may use different data structures and algorithms for tracking data related to orders and matching orders.

In operation, the exchange 230 may provide price data from the order book 232 to the price server 222 and order data and/or fill data from the matching engine 234 to the order server 224 and/or the fill server 226. Servers 222, 224, 226 may process and communicate this data to the trading device 210. The trading device 210, for example, using a trading application, may process this data. For example, the data may be displayed to a user. In another example, the data may be utilized in a trading algorithm to determine whether a trade order should be submitted to the exchange 230. The trading device 210 may prepare and send an order message to the exchange 230.

In certain embodiments, the gateway 220 is part of the trading device 210. For example, the components of the gateway 220 may be part of the same computing platform as the trading device 210. As another example, the functionality of the gateway 220 may be performed by components of the trading device 210. In certain embodiments, the gateway 220 is not present. Such an arrangement may occur when the trading device 210 does not need to utilize the gateway 220 to communicate with the exchange 230, such as if the trading device 210 has been adapted to communicate directly with the exchange 230.

### IV. Example Computing Device

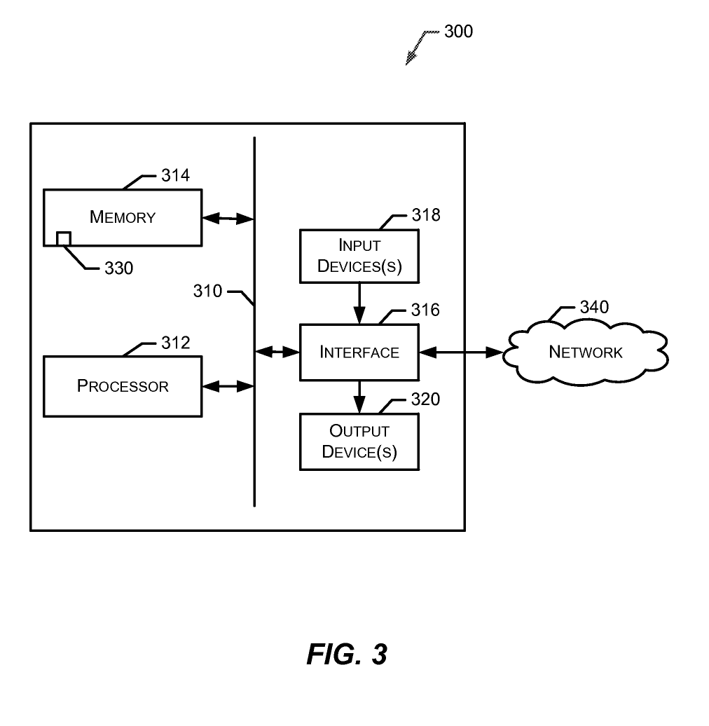

FIG. 3 illustrates a block diagram of an example computing device 300 which may be used to implement the disclosed embodiments. The trading device 110 of FIG. 1 may include one or more computing devices 300, for example. The gateway 120 of FIG. 1 may include one or more computing devices 300, for example. The exchange 130 of FIG. 1 may include one or more computing devices 300, for example.

The computing device 300 includes a communication network 310, a processor 312, a memory 314, an interface 316, an input device 318, and an output device 320. The computing device 300 may include additional, different, or fewer components. For example, multiple communication networks, multiple processors, multiple memory, multiple interfaces, multiple input devices, multiple output devices, or any combination thereof, may be provided. As another example, the computing device 300 may not include an input device 318 or output device 320.

As shown in FIG. 3, the computing device 300 may include a processor 312 coupled to a communication network 310. The communication network 310 may include a communication bus, channel, electrical or optical network, circuit, switch, fabric, or other mechanism for communicating data between components in the computing device 300. The communication network 310 may be communicatively coupled with and transfer data between any of the components of the computing device 300.

The processor 312 may be any suitable processor, processing unit, or microprocessor. The processor 312 may include one or more general processors, digital signal processors, application specific integrated circuits, field programmable gate arrays, analog circuits, digital circuits, programmed processors, and/or combinations thereof, for example. The processor 312 may be a single device or a combination of devices, such as one or more devices associated with a network or distributed processing. Any processing strategy may be used, such as multi-processing, multi-tasking, parallel processing, and/or remote processing. Processing may be local or remote and may be moved from one processor to another processor. In certain embodiments, the computing device 300 is a multi-processor system and, thus, may include one or more additional processors which are communicatively coupled to the communication network 310.

The processor 312 may be operable to execute logic and other computer readable instructions encoded in one or more tangible media, such as the memory 314. As used herein, logic encoded in one or more tangible media includes instructions which may be executable by the processor 312 or a different processor. The logic may be stored as part of software, hardware, integrated circuits, firmware, and/or micro-code, for example. The logic may be received from an external communication device via a communication network such as the network 340. The processor 312 may execute the logic to perform the functions, acts, or tasks illustrated in the figures or described herein.

The memory 314 may be one or more tangible media, such as computer readable storage media, for example. Computer readable storage media may include various types of volatile and non-volatile storage media, including, for example, random access memory, read-only memory, programmable read-only memory, electrically programmable read-only memory, electrically erasable read-only memory, flash memory, any combination thereof, or any other tangible data storage device. As used herein, the term non-transitory or tangible computer readable medium is expressly defined to include any type of computer readable medium and to exclude propagating signals. The memory 314 may include any desired type of mass storage device including hard disk drives, optical media, magnetic tape or disk, etc.

The memory 314 may include one or more memory devices. For example, the memory 314 may include local memory, a mass storage device, volatile memory, non-volatile memory, or a combination thereof. The memory 314 may be adjacent to, part of, programmed with, networked with, and/or remote from processor 312, so the data stored in the memory 314 may be retrieved and processed by the processor 312, for example. The memory 314 may store instructions which are executable by the processor 312. The instructions may be executed to perform one or more of the acts or functions described herein or shown in the figures.

The memory 314 may store a trading application 330. In certain embodiments, the trading application 330 may be accessed from or stored in different locations. The processor 312 may access the trading application 330 stored in the memory 314 and execute computer-readable instructions included in the trading application 330.

In certain embodiments, during an installation process, the trading application may be transferred from the input device 318 and/or the network 340 to the memory 314. When the computing device 300 is running or preparing to run the trading application 330, the processor 312 may retrieve the instructions from the memory 314 via the communication network 310.

### V. Strategy Trading

In addition to buying and/or selling a single tradeable object, a user may trade more than one tradeable object according to a trading strategy. One common trading strategy is a spread and trading according to a trading strategy may also be referred to as spread trading. Spread trading may attempt to capitalize on changes or movements in the relationships between the tradeable object in the trading strategy, for example.

In some examples, an algorithmic trading tool is used to design and execute a spread trading strategy. In some examples, an automated trading tool may be utilized to trade according to a trading strategy. For example, the automated trading tool may AUTOSPREADER®, provided by Trading Technologies.

A trading strategy defines a relationship between two or more tradeable objects to be traded. Each tradeable object being traded as part of a trading strategy may be referred to as a leg or outright market of the trading strategy.

When the trading strategy is to be bought, the definition for the trading strategy specifies which tradeable object corresponding to each leg should be bought or sold. Similarly, when the trading strategy is to be sold, the definition specifies which tradeable objects corresponding to each leg should be bought or sold. For example, a trading strategy may be defined such that buying the trading strategy involves buying one unit of a first tradeable object for leg A and selling one unit of a second tradeable object for leg B. Selling the trading strategy typically involves performing the opposite actions for each leg.

In addition, the definition for the trading strategy may specify a spread ratio associated with each leg of the trading strategy. The spread ratio may also be referred to as an order size for the leg. The spread ratio indicates the quantity of each leg in relation to the other legs. For example, a trading strategy may be defined such that buying the trading strategy involves buying 2 units of a first tradeable object for leg A and selling 3 units of a second tradeable object for leg B. The sign of the spread ratio may be used to indicate whether the leg is to be bought (the spread ratio is positive) or sold (the spread ratio is negative) when buying the trading strategy. In the example above, the spread ratio associated with leg A would be “2” and the spread ratio associated with leg B would be “−3.”

In some instances, the spread ratio may be implied or implicit. For example, the spread ratio for a leg of a trading strategy may not be explicitly specified, but rather implied or defaulted to be “1” or “−1.”

In addition, the spread ratio for each leg may be collectively referred to as the spread ratio or strategy ratio for the trading strategy. For example, if leg A has a spread ratio of “2” and leg B has a spread ratio of “−3”, the spread ratio (or strategy ratio) for the trading strategy may be expressed as “2:−3” or as “2:3” if the sign for leg B is implicit or specified elsewhere in a trading strategy definition.

Additionally, the definition for the trading strategy may specify a multiplier associated with each leg of the trading strategy. The multiplier is used to adjust the price of the particular leg for determining the price of the spread. The multiplier for each leg may be the same as the spread ratio. For example, in the example above, the multiplier associated with leg A may be “2” and the multiplier associated with leg B may be “−3,” both of which match the corresponding spread ratio for each leg. Alternatively, the multiplier associated with one or more legs may be different than the corresponding spread ratios for those legs. For example, the values for the multipliers may be selected to convert the prices for the legs into a common currency.

The following discussion assumes that the spread ratio and multipliers for each leg are the same, unless otherwise indicated. In addition, the following discussion assumes that the signs for the spread ratio and the multipliers for a particular leg are the same and, if not, the sign for the multiplier is used to determine which side of the trading strategy a particular leg is on.

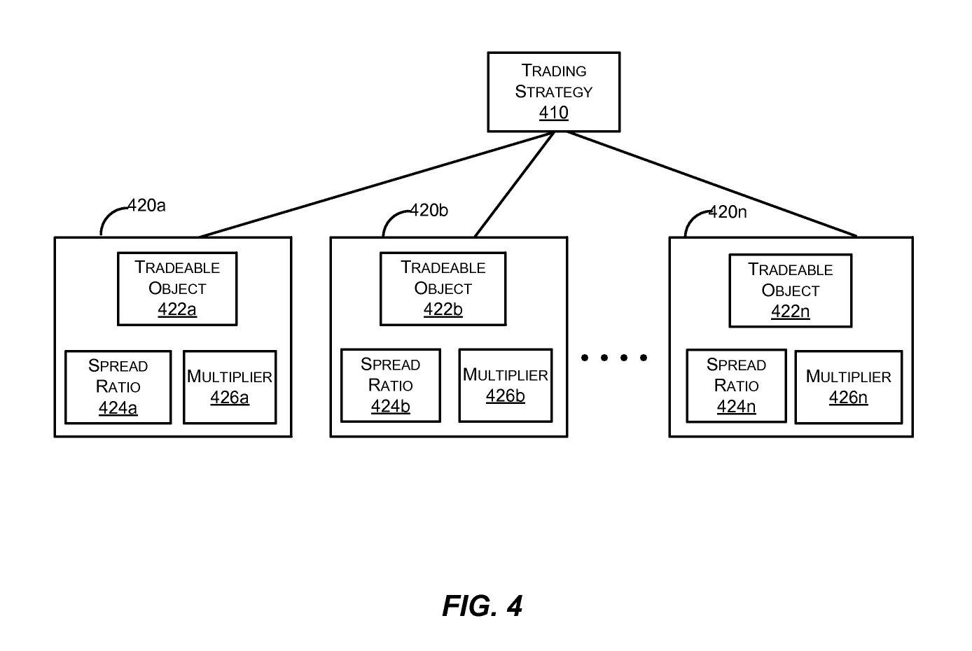

FIG. 4 illustrates a block diagram of a trading strategy 410 which may be employed with certain disclosed embodiments. The trading strategy 410 includes “n” legs 420 (individually identified as leg 420a to leg 420n). The trading strategy 410 defines the relationship between tradeable objects 422 (individually identified as tradeable object 422a to tradeable object 422n) of each of the legs 420a to 420n using the corresponding spread ratios 424a to 424n and multipliers 426a to 426n.

Once defined, the tradeable objects 422 in the trading strategy 410 may then be traded together according to the defined relationship. For example, assume that the trading strategy 410 is a spread with two legs, leg 420a and leg 420b. Leg 420a is for tradeable object 422a and leg 420b is for tradeable object 422b. In addition, assume that the spread ratio 424a and multiplier 426a associated with leg 420a are “1” and that the spread ratio 424b and multiplier 426b associated with leg 420b are “−1”. That is, the spread is defined such that when the spread is bought, 1 unit of tradeable object 422a is bought (positive spread ratio, same direction as the spread) and 1 unit of tradeable object 422b is sold (negative spread ratio, opposite direction of the spread). As mentioned above, typically in spread trading the opposite of the definition applies. That is, when the definition for the spread is such that when the spread is sold, 1 unit of tradeable object 422a is sold (positive spread ratio, same direction as the spread) and 1 unit of tradeable object 422b is bought (negative spread ratio, opposite direction of the spread).

The price for the trading strategy 410 is determined based on the definition. In particular, the price for the trading strategy 410 is typically the sum of price the legs 420 comprising the tradeable objects 422 multiplied by corresponding multipliers 426. The price for a trading strategy may be affected by price tick rounding and/or pay-up ticks. However, both of these implementation details are beyond the scope of this discussion and are well-known in the art.

Recall that, as discussed above, a real spread may be listed at an exchange, such as exchange 130 and/or 230, as a tradeable product. In contrast, a synthetic spread may not be listed as a product at an exchange, but rather the various legs of the spread are tradeable at one or more exchanges. For the purposes of the following example, the trading strategy 410 described is a synthetic trading strategy. However, similar techniques to those described below may also be applied by an exchange when a real trading strategy is traded.

Continuing the example from above, if it is expected or believed that tradeable object 422a typically has a price 10 greater than tradeable object 422b, then it may be advantageous to buy the spread whenever the difference in price between tradeable objects 422a and 422b is less than 10 and sell the spread whenever the difference is greater than 10. As an example, assume that tradeable object 422a is at a price of 45 and tradeable object 422b is at a price of 40. The current spread price may then be determined to be (1)(45)+(−1)(40)=5, which is less than the typical spread of 10. Thus, a user may buy 1 unit of the spread, which results in buying 1 unit of tradeable object 422a at a price of 45 and selling 1 unit of tradeable object 422b at 40. At some later time, the typical price difference may be restored and the price of tradeable object 422a is 42 and the price of tradeable object 422b is 32. At this point, the price of the spread is now 10. If the user sells 1 unit of the spread to close out the user's position (that is, sells 1 unit of tradeable object 422a and buys 1 unit of tradeable object 422b), the user has made a profit on the total transaction. In particular, while the user bought tradeable object 422a at a price of 45 and sold at 42, losing 3, the user sold tradeable object 422b at a price of 40 and bought at 32, for a profit of 8. Thus, the user made 5 on the buying and selling of the spread.

The above example assumes that there is sufficient liquidity and stability that the tradeable objects can be bought and sold at the market price at approximately the desired times. This allows the desired price for the spread to be achieved. However, more generally, a desired price at which to buy or sell a particular trading strategy is determined. Then, a trading algorithm, for example, attempts to achieve that desired price by buying and selling the legs at appropriate prices. For example, when a user designs the trading algorithm to buy or sell the trading strategy 410 at a desired price, the trading algorithm may be used to place an order (also referred to as quoting an order) for one of the tradeable objects 422 of the trading strategy 410 to achieve the desired price for the trading strategy (also referred to as a desired strategy price, desired spread price, and/or a target price). The leg for which the order is placed is referred to as the quoting leg. The other leg is referred to as a lean leg and/or a hedge leg. The price that the quoting leg is quoted at is based on a target price that an order could be filled at in the lean leg. The target price in the hedge leg is also known as the leaned on price, lean price, or lean level. Typically, if there is sufficient quantity available, the target price may be the best bid price when selling and the best ask price when buying. The target price may be different than the best price available if there is not enough quantity available at that price or because it is an implied price, for example. As the leaned on price changes, the price for the order in the quoting leg may also change to maintain the desired strategy price.

The leaned on price may also be determined based on a lean multiplier and/or a lean base. A lean multiplier may specify a multiple of the order quantity for the hedge leg that should be available to lean on that price level. For example, if a quantity of 10 is needed in the hedge leg and the lean multiplier is 2, then the lean level may be determined to be the best price that has at least a quantity of 20 available. A lean base may specify an additional quantity above the needed quantity for the hedge leg that should be available to lean on that price level. For example, if a quantity of 10 is needed in the hedge leg and the lean base is 5, then the lean level may be determined to be the best price that has at least a quantity of 15 available. The lean multiplier and lean base may also be used in combination. For example, the lean base and lean multiplier may be utilized such that larger of the two is used or they may be used additively to determine the amount of quantity to be available.

When the quoting leg is filled, the trading algorithm may be used to submit an order in the hedge leg to complete the strategy. This order may be referred to as an offsetting or hedging order. The offsetting order may be placed at the leaned on price or based on the fill price for the quoting order, for example. If the offsetting order is not filled (or filled sufficiently to achieve the desired strategy price), then the strategy order is said to be “legged up” or “legged” because the desired strategy relationship has not been achieved according to the trading strategy definition.

In addition to having a single quoting leg, as discussed above, a trading strategy may be quoted in multiple (or even all) legs. In such situations, each quoted leg still leans on the other legs. When one of the quoted legs is filled, typically the orders in the other quoted legs are cancelled and then appropriate hedge orders are placed based on the lean prices that the now-filled quoting leg utilized.

### VI. Example Risk Management Systems and Methods

When utilizing a trading strategy, such as an automated spread trading strategy, it may be desirable to utilize one or more risk management techniques to ensure that the user's risk account has a current risk balance sufficient to allow a trading application to initiate sending of a trade action specified by the automated trading strategy. Examples disclosed herein provide a system to confirm that the automated trading strategy is operating within risk-related limits (e.g., a position risk limit). For example, prior to activation of the trading strategy, the user may define a risk pool via the trading application. The risk pool is, in turn, queried before the trading strategy initiates sending of any trade actions in response to a detected condition in the market.

In some examples, a trading interface is provided to interact with an exchange, create trading strategies, and analyze information. One example of a trading interface may provide automated trading tools such as ADL which can be utilized to design, test and implement automated trading strategies. In certain examples, the trading interface may include one or more blocks or objects that can be configured and arranged to define a trading algorithm to execute a trading strategy such as a spread. For example, the trading interface may include a design canvas area configured to allow a user to visually define an automated trading algorithm by selecting various algorithm blocks and connecting the inputs and outputs of those blocks to create a trading algorithm that may be implemented to execute trades at an exchange.

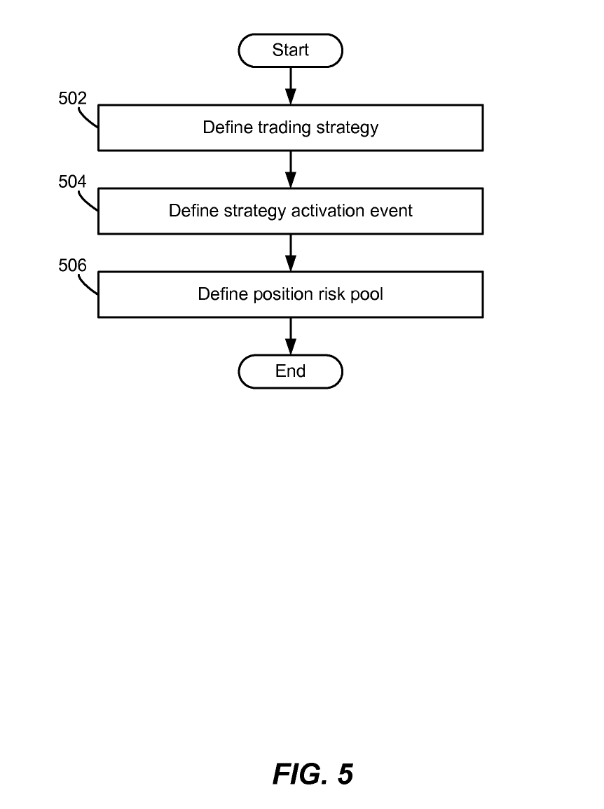

FIG. 5 illustrates a flow diagram of an example method for defining a trading strategy. The example of FIG. 5 enables a user to define a trading strategy, a strategy activation event, and/or a position risk pool via, for example, a trading algorithm in a trading interface prior to the trading strategy initiating sending of a trade action. Initially, a trading strategy is defined (block 502). A trading strategy defines a relationship between two or more tradeable objects to be traded. Each tradeable object being traded as part of a trading strategy may be referred to as a leg or outright market of the trading strategy. Defining the trading strategy includes defining the tradeable objects to be traded and the relationship between the defined tradeable objects. The definition for the trading strategy specifies which tradeable object corresponding to each leg should be bought or sold. For example, a trading strategy may be defined such that buying the trading strategy involves buying one unit of a first tradeable object for leg A and selling one unit of a second tradeable object for leg B. Selling the trading strategy typically involves performing the opposite actions for each leg.

Defining the trading strategy may also include specifying a spread ratio associated with each leg of the trading strategy. The spread ratio may also be referred to as an order size for the leg. The spread ratio indicates the quantity of each leg in relation to the other legs. Defining the trading strategy may also include specifying a multiplier associated with each leg of the trading strategy. The multiplier is used to adjust the price of the particular leg for determining the price of the spread. The multiplier for each leg may be the same as the spread ratio. Alternatively, the multiplier associated with one or more legs may be different than the corresponding spread ratios for those legs. For example, the values for the multipliers may be selected to convert the prices for the legs into a common currency.

A strategy activation event is also defined (block 504). A strategy activation event refers to an event that, when detected, will initiate operation of the trading strategy. In other words, when a strategy activation event is detected, a trading algorithm defining the trading strategy runs to begin execution of one or more trade actions specified by the trading strategy such as sending orders to an exchange pursuant to the strategy. The strategy activation event may be defined based on market conditions, times of day or week, current events, etc. Information related to market conditions, times of day or week, current events, etc. may then be collected and monitored to determine when the defined strategy activation event occurs.

A position risk pool is also defined (block 506). The position risk pool is used to confirm a trading algorithm executing an automated trading strategy is operating within risk-related limits prior to initiating sending of a trade action specified by the trading strategy. In the illustrated example, the position risk pool set by a user defines a quantity of orders not to be exceeded by the trading strategy. The position risk pool represents a quantity of orders that may be sent into the market while the automated trading strategy is executing. In other words, the position risk pool represents the maximum potential risk that may be experienced during the operation of the automated trading strategy. In some examples, the position risk pool set by a user defines a profit and/or loss margin associated with the user not to be exceeded by the trading strategy. A profit and/or loss margin is a comparison of a current value of one or more trades (e.g., today) to a past value of one or more trades (e.g., yesterday). While the illustrated example discusses a position risk pool being associated with a single automated trading strategy, a position risk pool may also be associated with more than one trading strategy, such as a group of related trading strategies, multiple trading strategies associated with a single user, multiple trading strategies associated with a firm, etc. The example flow diagram of FIG. 5 then ends.

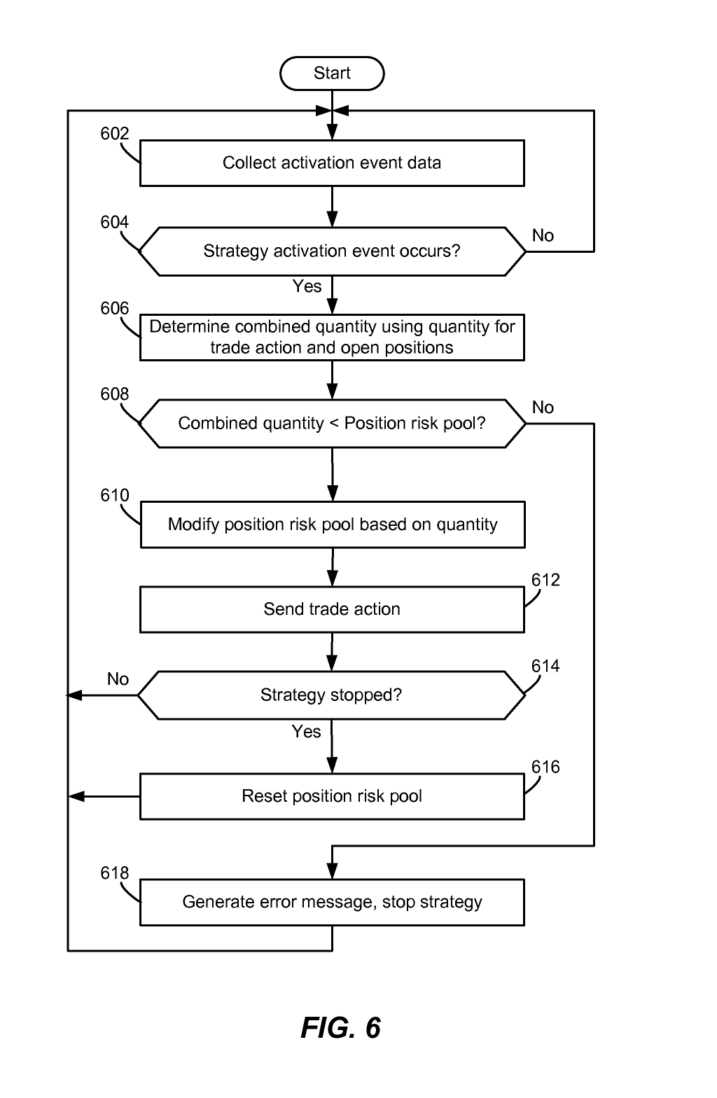

FIG. 6 illustrates a flow diagram of an example method for implementing an automated trading strategy. Once a trading strategy and an overall position risk pool or limit has been defined (e.g., using the method of FIG. 5), the trading strategy may be activated to monitor one or more markets. The activated trading algorithm may, when a desired condition is detected in the market, initiate sending of a trade action. Initially, activation event data is collected (block 602). Activation event data includes information related to market conditions, times of day or week, current events, etc. that may affect the trading strategy. The activation event data is monitored to determine if a strategy activation event (e.g., the strategy activation event defined in FIG. 5) has occurred (block 604). Detection of a strategy activation event may include a determination that a desired market condition has occurred, a classification or other identification of the desired market condition, and/or the storage or recordation of the desired market condition. Control remains at block 604 until a strategy activation event is detected.

If a strategy activation event is detected, the trading strategy is to be implemented and a combined quantity is determined (block 606). The combined quantity includes a quantity associated with the trade action (e.g., an order to be placed according to the trading strategy) and quantities associated with open positions of a user. The quantity and a price for the trade action (e.g., the order to be placed according to the trading strategy) are determined using market data received from, for example, an exchange to be used to execute trade actions by the trading strategy. In a spread trading strategy, the price and the quantity may be associated with any of one or more legs of the spread. Open positions include trades that have been established and/or entered by, for example, a trading algorithm, but have not yet been closed. The combined quantity adds the quantity for the trade action (e.g., the order to be placed) to quantities of the open positions associated with the user. For example, where the quantity associated with the trade action (e.g., the order to be placed according to the trading strategy) is ten and the quantities associated with the open positions is twenty, the combined quantity is thirty.

The combined quantity is compared to a previously defined position risk limit (e.g., the position risk pool defined in FIG. 5) to determine if the combined quantity exceeds the position risk limit associated with the (block 608). If the combined quantity does not exceed the position risk limit, the value of the position risk pool is modified based on the combined quantity (block 610). For example, if the position risk limit associated with the position risk pool is 10 and the combined quantity is 4, the value of the position risk pool is updated to 6. Once the value of the position risk pool has been modified, the trading strategy initiates sending of the trade action (e.g., an order is sent to an exchange with the price and approved quantity) (block 612). In some examples, the quantity associated with the order to be placed according to the trading strategy is compared to the position risk limit to determine if the trading strategy may be implemented.

It is then determined if the trading strategy has been stopped (e.g., if the trading algorithm has stopped executing) (block 614). If the trading strategy has not been stopped, control returns to block 602 where activation event data is collected and monitored to detect another occurrence of a strategy activation event. If the trading strategy has been stopped (e.g., the trading algorithm has been executed), the position risk limit is reset (block 616). For example, once the trading algorithm has stopped executing, the position risk limit is reset to 10 so that when the trading algorithm is again launched, the original position risk limit is used for monitoring the trading strategy executed by the trading algorithm. Control returns to block 602 to collect activation event data.

If the combined quantity is compared to the position risk limit (block 608) and the combined quantity exceeds the position risk limit, an error message is generated and the trading strategy is prevented from executing (e.g., prevented from sending the trade action) (block 618). The error message may be generated (e.g., as a text box) to inform a user that the position risk limit was exceeded and, thus, the trading strategy may not be used at the specified quantity. Control then returns to block 602 where activation event data is monitored to detect another occurrence of a strategy activation event.

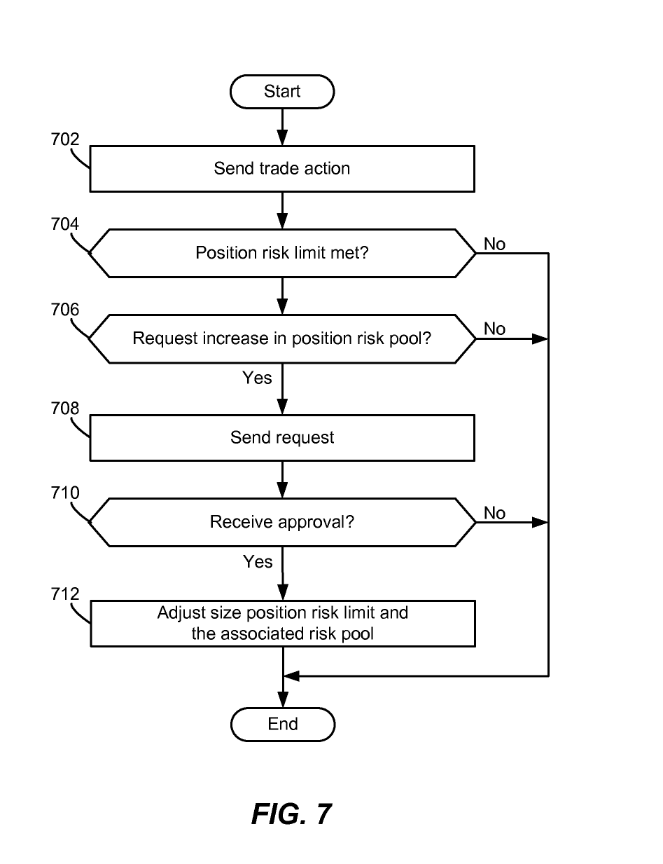

FIG. 7 illustrates a flow diagram of an example method for increasing a position risk pool or other risk-related limit. In some examples, if a position risk limit associated with a risk pool has been met when executing a trading strategy, an increase in the size of the position risk pool may be allowed. Initially, a trade action is sent (e.g., an order for a tradeable object is sent) (block 702). The trade action (e.g., the order for the tradeable object) is sent using the example method of FIG. 6.

It is then determined if the position risk limit associated with a risk pool has been met (block 704). The position risk limit will be met if, for example, a combined quantity including a quantity associated with the trade action (e.g., a quantity of the order placed at step 702) and quantities associated with open positions of a user is the same as the position risk limit. If the position risk limit has not been met, the example method of FIG. 7 ends. If the position risk limit has been met, it is determined if a request for an increase in position risk limit is to be sent (block 706). In some examples, a user may allow requests for increases in the size of the position risk pool. The request may specify a particular amount the position risk pool is to be increased, or a standard increment may be used. In some examples, a user may not allow requests for increases in position risk limits. In some such examples, if a request for an increased position risk limit is not allowed, and the position risk limit has been met, the trading strategy is stopped. Where a request for an increase in the position risk limit is not to be sent, the example method of FIG. 7 ends.

If a request to increase the position risk limit associated with a risk pool is to be sent, the request is sent to a user (block 708). If approval of the request is not received from the user, the example method of FIG. 7 ends, and the trading strategy will be stopped. If approval of the request is received from the user (block 710), the size of the position risk limit associated with a risk pool is adjusted (block 712). For example, if the position risk limit is 10, and the position risk limit was met, the position risk limit may be raised to 20. The trading strategy continues to be executed and the new position risk pool of 20 is used when determining whether to allow a trade order to be sent. The example method of FIG. 7 then ends.

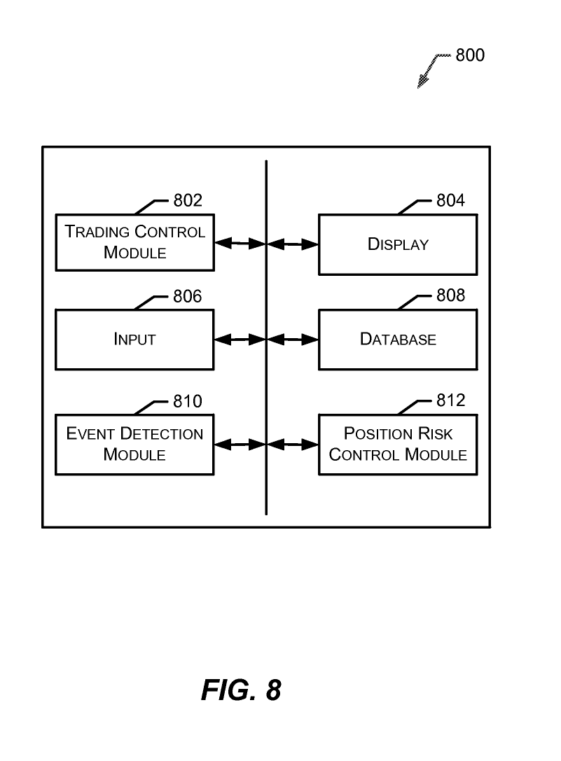

FIG. 8 is a block diagram of an example implementation of an example trading manager 800 which may be used to implement disclosed embodiments. The example trading manager 800 of FIG. 8 may be implemented at a trading device (e.g., the trading device 110 of FIG. 1). The example trading manager 800 is used to confirm a trading algorithm executing a trading strategy is operating within risk-related limits (e.g., within the position risk pool) set by a user prior to activation of the trading strategy (e.g., prior to sending a trade order pursuant to the trading strategy). The example trading manager 800 of FIG. 8 includes an example trading control module 802, an example display 804, an example input 806, an example database 808, an example event detection module 810, and an example position risk control module 812.

The example trading control module 802 is used to define a trading strategy, a strategy activation event, and/or a position risk limit prior to the trading strategy initiating sending of a trade action. A trading strategy defines a relationship between two or more tradeable objects to be traded. Each tradeable object being traded as part of a trading strategy may be referred to as a leg or outright market of the trading strategy. Defining the trading strategy includes defining the tradeable objects to be traded and the relationship between the defined tradeable objects. Defining the trading strategy may also include specifying a spread ratio associated with each leg of the trading strategy and may also include specifying a multiplier associated with each leg of the trading strategy

A strategy activation event refers to an event that, when detected, will initiate execution of one or more trade actions specified by the trading strategy. Detection of a strategy activation event may include a determination that a desired market condition has occurred, a classification or other identification of the desired market condition, and/or the storage or recordation of the desired market condition. When a strategy activation event is detected, a trading algorithm defining the trading strategy runs to begin sending trade actions (e.g., begins sending orders to an exchange pursuant to the strategy). The strategy activation event may be defined based on market conditions, times of day or week, current events, etc.

A position risk limit established in connection with the position risk pool is used to confirm a trading algorithm executing a trading strategy is operating within risk-related limits prior to initiating sending of a trade action specified by the trading strategy. In some examples, the position risk pool set by a user defines a quantity associated with the trade action (e.g., a quantity of orders associated with the user) not to be exceeded by the trading strategy. In some examples, the position risk pool set by a user defines a profit and/or loss margin associated with the user not to be exceeded by the trading strategy. In some examples, a position risk pool is associated with a single automated trading strategy. In some examples, a position risk pool is associated with more than one trading strategy, such as a group of related trading strategies, multiple trading strategies associated with a single user, multiple trading strategies associated with a firm, etc.

The example trading control module 802 prompts a user to define the trading strategy, strategy activation event, and/or position risk pool via the example display 804 and the user defines the trading strategy, strategy activation event, and/or position risk limit via the example input 806. The trading strategy, strategy activation event, and/or position risk pool may be defined via a trading interface that is provided to interact with an exchange, create trading strategies, and analyze information. The trading interface may provide one or more blocks or objects that can be configured and arranged to define a trading algorithm to execute a trading strategy. For example, the trading interface may include a design canvas area configured to allow a user to visually define a trading algorithm by selecting various algorithm blocks and connecting inputs and outputs of those blocks to create a trading algorithm that may be implemented to execute trades at one or more exchanges via one or more gateways. Once defined, the trading strategy, strategy activation event, and/or position risk limit are stored in the example database 808.

The example event detection module 810 collects activation event data. Activation event data includes information related to market conditions, times of day or week, current events, etc. that may affect the trading strategy. The example event detection module 810 monitors the activation event data to determine if the defined strategy activation event has occurred.

Once the strategy activation event is detected, the example position risk control module 812 determines a price and a quantity associated with the trade action (e.g., a quantity for a tradeable object defined by the trading strategy). For example, a price and a quantity for an order to be placed according to the trading strategy are determined using market data received from, for example, an exchange to be used to execute trades by the trading strategy. The example position risk control module 812 also determines open positions associated with the user. Open positions include trades that have been established and/or entered by, for example, a trading algorithm, but have not yet been closed. The example position risk control module 812 determines a combined quantity including the quantity associated with the trade action (e.g., the order to be placed according to the trading strategy) and quantities associated with the open positions.

The example position risk control module 812 compares the combined quantity to the defined position risk limit associated with a risk pool to determine if the combined quantity exceeds the position risk limit. If the combined quantity does not exceed value established as part of the position risk limit, the example position risk control module 812 modifies the size of the position risk pool based on the combined quantity. For example, if the position risk limit is 10 and the combined quantity is 4, the position risk limit is updated to 6. Once the position risk limit has been modified, the trading strategy initiates sending of the trade action, and the example trading control module 802 sends an order to an exchange with the price and approved quantity.

The example position risk control module 812 determines if the trading strategy has been stopped (e.g., if the trading algorithm has stopped executing). If the trading strategy has not been stopped, the example event detection module 810 continues to collect and monitor activation event data to detect another occurrence of a strategy activation event. If the trading strategy has been stopped (e.g., the trading algorithm has been executed), the example position risk control module 812 resets the position risk limit associated with a risk pool. For example, once the trading algorithm has stopped executing, the position risk limit associated with a risk pool is reset to 10 so that when the trading algorithm is again launched, the original position risk limit is used for monitoring the trading strategy executed by the trading algorithm.

If the example position risk control module compares the combined quantity to the position risk pool and the combined quantity exceeds the position risk limit associated with a risk pool, the example position risk control module 812 generates an error message to be displayed via the example display 804 and the example trading control module 802 prevents the trading strategy from initiating sending of the trade action. The example position risk control module 812 generates the error message (e.g., as a text box) to inform a user that the position risk limit was exceeded and, thus, the trading strategy may not be used at the specified quantity.

In some examples, if the position risk associated with an automated trading strategy exceeds the risk limit or value established as part of the risk pool, an increase in the position risk limit may be allowed. The example position risk control module determines if the position risk limit associated with a risk pool has been met. The position risk limit will be met if, for example, a combined quantity including a quantity associated with the trade order (e.g., allowed trade order) is the same as the value established as part of the position risk pool. If the position risk limit has been met, the example position risk control module may send a request for an increase in position risk limit. In some examples, a user may allow requests for increases in position risk limits. The request may specify a particular amount the position risk limited is to be increased, or a standard increment may be used. In some examples, a user may not allow requests for increases in position risk limits. In some such examples, if a request for an increased position risk limit is not allowed, and the position risk limit has been met, the example trading control module 802 stops the trading strategy.

The example position risk control module 812 sends a request to increase the position risk limit associated with a risk pool to the user via the example display 804. If approval of the request is not received from the user, the example trading control module 802 stops the trading strategy. If approval of the request is received from the user via the example input 806, the example position risk control module 812 increases the size position risk pool and any relevant position risk limit. For example, if the position risk pool contains a value of 10, and the position risk limit was met, the example position risk control module may raise the available value of the position risk pool to 20. The trading strategy continues to be executed by the example trading control module 802 and the example position risk control module 812 uses the new position risk limit of 20 when determining whether to allow a trade order to be sent.

In an example operation, a user creates an automated trading algorithm via, for example, a trading interface. The trading interface may provide one or more blocks or objects that can be configured and arranged to define the trading algorithm to execute a trading strategy. When creating the trading algorithm to define a trading strategy, the user also defines a strategy activation event and/or a position risk pool associated with the automated trading algorithm. The strategy activation event is used to determine when to activate the trading algorithm (e.g., upon an occurrence of a particular market event and/or condition). The position risk pool defines a quantity of an order that may not be exceeded during the operation of the automated trading algorithm.

Once the trading algorithm has been created, the algorithm may be executed such that information is exchanged with one or more exchanges via one or more gateways. Upon detection of a strategy activation event, a trade action associated with the automated trading strategy (e.g., an order to be placed by the trading algorithm including a price and a quantity) is examined to see if the potential trade action increases the position risk associated with the automated trading algorithm beyond the risk limits established as part of the position risk pool. A combined quantity including the quantity associated with the trade action (e.g., the quantity of the order to be placed) and quantities of open positions of the user is compared to the available risk balance associated with the position risk pool. If the combined quantity is below the position risk limit (e.g., the risk balance is greater than zero), the trade action is approved and is sent for execution to the exchange. If the combined quantity is above the position risk limit (e.g., the risk balance has been exhausted), the trade action is not approved, and the trading algorithm is stopped from initiating sending of the trade action so that the position risk limit is not exceeded.

Some of the described figures depict example block diagrams, systems, and/or flow diagrams representative of methods that may be used to implement all or part of certain embodiments. One or more of the components, elements, blocks, and/or functionality of the example block diagrams, systems, and/or flow diagrams may be implemented alone or in combination in hardware, firmware, discrete logic, as a set of computer readable instructions stored on a tangible computer readable medium, and/or any combinations thereof, for example.

The example block diagrams, systems, and/or flow diagrams may be implemented using any combination of application specific integrated circuit(s) (ASIC(s)), programmable logic device(s) (PLD(s)), field programmable logic device(s) (FPLD(s)), discrete logic, hardware, and/or firmware, for example. Also, some or all of the example methods may be implemented manually or in combination with the foregoing techniques, for example.

The example block diagrams, systems, and/or flow diagrams may be performed using one or more processors, controllers, and/or other processing devices, for example. For example, the examples may be implemented using coded instructions, for example, computer readable instructions, stored on a tangible computer readable medium. A tangible computer readable medium may include various types of volatile and non-volatile storage media, including, for example, random access memory (RAM), read-only memory (ROM), programmable read-only memory (PROM), electrically programmable read-only memory (EPROM), electrically erasable read-only memory (EEPROM), flash memory, a hard disk drive, optical media, magnetic tape, a file server, any other tangible data storage device, or any combination thereof. The tangible computer readable medium is non-transitory.

Further, although the example block diagrams, systems, and/or flow diagrams are described above with reference to the figures, other implementations may be employed. For example, the order of execution of the components, elements, blocks, and/or functionality may be changed and/or some of the components, elements, blocks, and/or functionality described may be changed, eliminated, sub-divided, or combined. Additionally, any or all of the components, elements, blocks, and/or functionality may be performed sequentially and/or in parallel by, for example, separate processing threads, processors, devices, discrete logic, and/or circuits.

While embodiments have been disclosed, various changes may be made and equivalents may be substituted. In addition, many modifications may be made to adapt a particular situation or material. Therefore, it is intended that the disclosed technology not be limited to the particular embodiments disclosed, but will include all embodiments falling within the scope of the appended claims.

What is claimed is:

1. A method for algorithmic trading in an electronic trading environment, the method comprising:
receiving, at a computing device, a definition for an algorithmic spread trading strategy including a desired spread price and a strategy activation event, wherein the spread trading strategy is between a first tradeable object and a second tradeable object;
defining a position risk pool, wherein the position risk pool defines a maximum risk position associated with an instance of the algorithmic spread trading strategy;
detecting, at the computing device, an occurrence of the strategy activation event within one or more markets offering the first tradeable object and the second tradeable object;
calculating, at the computing device, a first price and a first quantity for the first tradeable object, wherein the first price and the first quantity are computed based on market conditions in the second tradeable object;
determining a second quantity including the first quantity and a third quantity associated with an open trade;
comparing the second quantity to the position risk pool; and
sending, by the computing device, a first order to buy or sell the first tradeable object of the algorithmic spread trading strategy if the second quantity does not exceed the position risk pool, wherein the first quantity of the first order is submitted at the first price.

2. The method of claim 1 further comprising:
adjusting the position risk pool based on at least the second quantity and the definition for the algorithmic spread trading strategy.

3. The method of claim 1 further comprising:
rejecting, by the computing device, the first order to buy or sell the first tradeable object of the algorithmic spread trading strategy if the second quantity exceeds the position risk pool.

4. The method of claim 1 wherein the position risk pool defines a position reserve including a first reserve quantity.

5. The method of claim 4 wherein the first reserve quantity comprises a pre-allocated risk allowance.

6. The method of claim 5 wherein the pre-allocated risk allowance is associated with a plurality of instances of the algorithmic spread trading strategy.

7. The method of claim 1 further comprising:
sending a request to increase the position risk pool; and
if the request is approved, increasing the position risk pool.

8. A system for algorithmic trading in an electronic trading environment, the system comprising:
a trading control module to:
receive a definition for an algorithmic spread trading strategy including a desired spread price and a strategy activation event, wherein the spread trading strategy is between a first tradeable object and a second tradeable object; and
define a position risk limit, wherein the risk position limit is associated with an instance of the algorithmic spread trading strategy; an event detection module to:
detect an occurrence of the strategy activation event within one or more markets offering the first tradeable object and the second tradeable object; and a position risk control module to:
calculate a first price and a first quantity for the first tradeable object, wherein the first price and the first quantity are computed based on market conditions in the second tradeable object;
determine a second quantity including the first quantity and a third quantity associated with an open trade; and
compare the second quantity to the position risk limit, wherein the trading control module is to send a first order to buy or sell the first tradeable object of the algorithmic spread trading strategy if the second quantity does not exceed the position risk limit, wherein the first quantity of the first order is submitted at the first price.

9. The system of claim 8 further wherein the position risk control module is to adjust the position risk limit based on at least the second quantity and the definition for the algorithmic spread trading strategy.

10. The system of claim 8 wherein the position risk control module is to reject the first order to buy or sell the first tradeable object of the algorithmic spread trading strategy if the second quantity exceeds the position risk limit.

11. The system of claim 8 wherein the position risk limit defines a position reserve including a first reserve quantity.

12. The system of claim 11 wherein the first reserve quantity comprises a pre-allocated risk allowance.

13. The system of claim 12 wherein the pre-allocated risk allowance is associated with a plurality of instances of the algorithmic spread trading strategy.

14. The system of claim 8 wherein the position risk control module is to send a request to increase the position risk limit and increase the position risk limit if the request is approved.

15. A tangible computer-readable storage medium comprising instructions that, when executed, cause a computing device to at least:
receive a definition for an algorithmic spread trading strategy including a desired spread price and a strategy activation event, wherein the spread trading strategy is between a first tradeable object and a second tradeable object;
define a position risk limit, wherein the risk position limit is associated with an instance of the algorithmic spread trading strategy;
detect an occurrence of the strategy activation event within one or more markets offering the first tradeable object and the second tradeable object;
calculate a first price and a first quantity for the first tradeable object, wherein the first price and the first quantity are computed based on market conditions in the second tradeable object;
determine a second quantity including the first quantity and a third quantity associated with an open trade;
compare the second quantity to the position risk limit; and
send a first order to buy or sell the first tradeable object of the algorithmic spread trading strategy if the second quantity does not exceed the position risk limit, wherein the first quantity of the first order is submitted at the first price.

16. The computer-readable storage medium of claim 15, further comprising instructions to cause the computing device to adjust the position risk limit based on at least the second quantity and the definition for the algorithmic spread trading strategy.

17. The computer-readable storage medium of claim 15, further comprising instructions to cause the computing device to reject the first order to buy or sell the first tradeable object of the algorithmic spread trading strategy if the second quantity exceeds the position risk limit.

18. The computer-readable medium of claim 15 wherein the position risk limit defines a position reserve including a first reserve quantity.

19. The computer-readable medium of claim 18 wherein the first reserve quantity comprises a pre-allocated risk allowance.

20. The computer-readable storage medium of claim 15, further comprising instructions to cause the computing device to send a request to increase the position risk limit and increase the position risk limit if the request is approved.
